(19) United States
(12) Patent Application Publication
(10) Pub. No.: US 2018/0136457 A1
(43) Pub. Date: May 17, 2018

(54) WAVELENGTH CONVERTER

(71) Applicant: DELTA ELECTRONICS, INC., Taoyuan City (TW)

(72) Inventors: Keh-Su CHANG, Taoyuan City (TW); Chun-Hsien LU, Taoyuan City (TW); Yen-I CHOU, Taoyuan City (TW); Chi CHEN, Taoyuan City (TW)

(21) Appl. No.: 15/458,046

(22) Filed: Mar. 14, 2017

(30) Foreign Application Priority Data
Nov. 14, 2016 (TW) 105137034

(51) Int. Cl. G02B 26/00; F21V 9/16; G02B 7/00

(52) U.S. Cl. CPC G02B 26/008; G02B 7/008; F21V 9/16

(57) ABSTRACT

A wavelength converter includes a substrate, a phosphor layer, a light transmission member, and a centroid adjustment member. The substrate is configured to be sleeved onto a drive shaft of a motor and has a hollow hole located within an outer edge of the substrate. The phosphor layer is disposed on the substrate and adjoins, the hollow hole. The light transmission member is embedded in the hollow hole. The centroid adjustment member is disposed on the substrate and located outside an outer edge of the phosphor layer and an outer edge of the light transmission ember An equivalent centroid of a combination of the substrate, the phosphor layer, the light transmission member, and the centroid adjustment member is substantially located on the axis of the drive shaft.

### RELATED APPLICATIONS

This application claims priority to Taiwan Application Serial Number 105137034, filed Nov. 14, 2016, which is herein incorporated by reference.

### BACKGROUND

### Technical Field

The present disclosure relates to a wavelength converter, and more particularly, to a color wheel applied in a projector.

### Description of Related Art

A phosphor wheel is a wavelength converter and is a key optical component in a laser projector, so as to convert laser light sources into fluorescent light sources. After the wavelength converting material on the phosphor wheel absorbs a certain range of wavelengths, internal electrons transition from ground state to excited state and release energy by way of releasing photons and phonons. Photon conversion means that the excited state electrons release photons having other wavelengths as light sources of the projector while transitioning to the ground state. Phonon conversion means that the excited state electrons release energy by way of directly releasing heat in the energy band such that the temperature of the phosphor wheel rises.

In general, the wavelength converter has two designs respectively according to 3-chip projectors and 1-chip projectors. The design of the wavelength converter applied in a 1-chip projector is more complicated. After the incident light arrives the wavelength converter, all or most of the incident light will be outputted in certain timing sequence (i.e., the incident light will not be converted by the wavelength coinverter). In order to allow the incident light to pass through, the substrate of the wavelength converter must has a light-permeable region. There exists two designs: (1) through hole design; and (2) glass composite design.

The substrate with the through hole design has a through hole formed as an outer edge of the substrate for the incident light to pass through, which has the advantage of simple structure. However, the shape of the outer edge the substrate with the through hole design is not a perfect circle, so the substrate generate loud wind noise while rotating. Furthermore, the structure of the substrate is a centroid asymmetric design, which needs the compensation to make the centroid of the whole rotating assembly be close to the rotation center. Otherwise, the motor may be easily damaged, and the bad rotating balance will cause vibration and noise. In other words, the substrate with the through hole design has disadvantages of load noise arid bad rotating balance.

The substrate with the glass composite design replaces the through hole with a piece of glass. The piece of glass can make the centroid of the whole rotating assembly be close to the rotation center, so that the substrate with the glass composite design has advantages of good rotating balance and small noise. However, the piece of glass is adhered to the drive shaft of the motor o other component, so the piece of glass may fly out in the case of high-speed rotation, and the probability of the separation of the piece of glass is getting higher along with the increased radius of the substrate. Once the piece of glass separates, the whole projector may be destroyed. Moreover, owing to the small thermal conductivity of the glass, the substrate with the glass composite design also has the disadvantage of poor cooling effect.

### SUMMARY

An aspect of the disclosure is to provide a wavelength converter which can further improve the excitation efficiency of the fluorescent element under the circumstances of the heat accumulation can be reduced to avoid the occurrence of thermal decay of the fluorescent element.

According to an embodiment of the disclosure, a wavelength converter includes a substrate, a phosphor layer, a light transmission member, and a centroid adjustment member. The substrate is configured to be sleeved onto a drive shaft of a motor and has a hollow hole located within an outer edge of the substrate. The phosphor layer is disposed on the substrate and adjoins the hollow hole. The light transmission member is embedded in the hollow hole. The centroid adjustment member is disposed on the substrate and located outside an outer edge of the phosphor layer and an outer edge of the light transmission member. An equivalent centroid of a combination of the substrate, the phosphor layer, the light transmission member, and the centroid adjustment member is substantially located on the axis of the drive shaft.

In an embodiment of the disclosure, the centroid adjustment member is a weight-loading member.

In an embodiment of the disclosure, the centroid adjustment member through hole.

In an embodiment of the disclosure, the outer edge of the substrate has a first outer diameter relative to the axis of the drive shaft. An outer edge of the hollow hole has a second outer diameter relative to the axis of the drive shaft. The outer edge of the phosphor layer has a third outer diameter relative to the axis of the drive shaft. The first outer diameter is greater than the second outer diameter. The second outer diameter is equal to or greater than the third outer diameter.

In an embodiment of the disclosure, the substrate further has two of the hollow holes. The axis of the drive shaft is substantially located between the hollow holes. The wavelength converter further includes two of the light transmission members. The light transmission members are respectively embedded in the hollow holes.

In an embodiment of the disclosure, a portion of the substrate located outside the outer edge of the phosphor layer and the outer edge of the fight transmission member is substantially ring-shaped.

According to another embodiment of the disclosure, a wavelength converter includes a substrate, a phosphor layer, a light transmission member, a first centroid adjustment member, and a second centroid adjustment member. The substrate is configured to be sleeved onto a drive shaft of a motor and has a hollow hole located within an outer edge of the substrate. The phosphor layer is disposed on the substrate and adjoining the hollow hole. The light transmission member is embedded in the hollow hole. The first centroid adjustment member is disposed on the substrate and located outside an outer edge of the phosphor layer and an outer edge of the light transmission member. The second centroid adjustment member is disposed on the substrate and located inside an inner edge of the phosphor layer. An equivalent centroid of a combination of the substrate, the phosphor layer, the light transmission member, the first centroid adjustment member, and the second centroid adjustment member is substantially located on the axis of the drive shaft.

In an embodiment of the disclosure, the first centroid adjustment member is a weight-loading member.

In an embodiment of the disclosure the first centroid adjustment member is a through hole.

In an embodiment of the disclosure, the second centroid adjustment member includes a collar and a plurality of weight-loading members. The collar is fixed to the substrate and configured to be sleeved onto the drive shaft. The weight-loading members are disposed on the collar.

Accordingly, the wavelength converter of the present disclosure can be applied in a 1-chip projector and has a design that the light transmission bar is embedded in the hollow hole located within the outer edge of the substrate (i.e., the light transmission member is wrapped in the substrate). Hence, the wavelength converter of the present disclosure can maintain the shape of a circular symmetrical structure and can avoid the wind noise caused by the conventional substrate with the through hole design. The light transmission member embedded in the hollow hole and the centroid adjustment member disposed on the substrate can move the equivalent centroid of the wavelength converter to the axis of the drive shaft, so the wavelength converter of the present disclosure has a good dynamic balance. Furthermore, because the light transmission member is embedded in the hollow hole a portion of the substrate must serve as a retaining wall structure to fix the light transmission member in a mechanical interlocking manner and resist the centrifugal force during rotation, so as to prevent the light transmission member from being separated from the substrate. In addition, the, substrate can be made of metal, so the retaining wall structure can increase the heat dissipating area and the heat capacity of the substrate, and the cooling efficiency can be improved.

It is to be understood that both the foregoing general description and the following detailed description are, by examples and are intended to provide further explanation of the disclosure as claimed.

### BRIEF DESCRIPTION OF THE DRAWINGS

The disclosure can be more fully understood by reading the following detailed description of the embodiment, with reference made to the accompanying drawing as follows:

FIG. 1 is a front view of a wavelength converter according to an embodiment of the disclosure;

FIG. 2 is a cross-sectional view of the wavelength converter in FIG. 1 taken along line 2-2;

FIG. 3 is a front view of a wavelength converter according to another embodiment of the disclosure;

FIG. 4 is a cross-sectional view of the wavelength converter in FIG. 3 taken along line 4-4;

FIG. 5 is a front view of a wavelength converter according to another embodiment of the disclosure;

FIG. 6 is a front view of a wavelength converter according to another embodiment of the disclosure;

FIG. 7 is a front view of a wavelength converter according to another embodiment of the disclosure; and

FIG. 8 is a front view of a wavelength, converter according to another embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

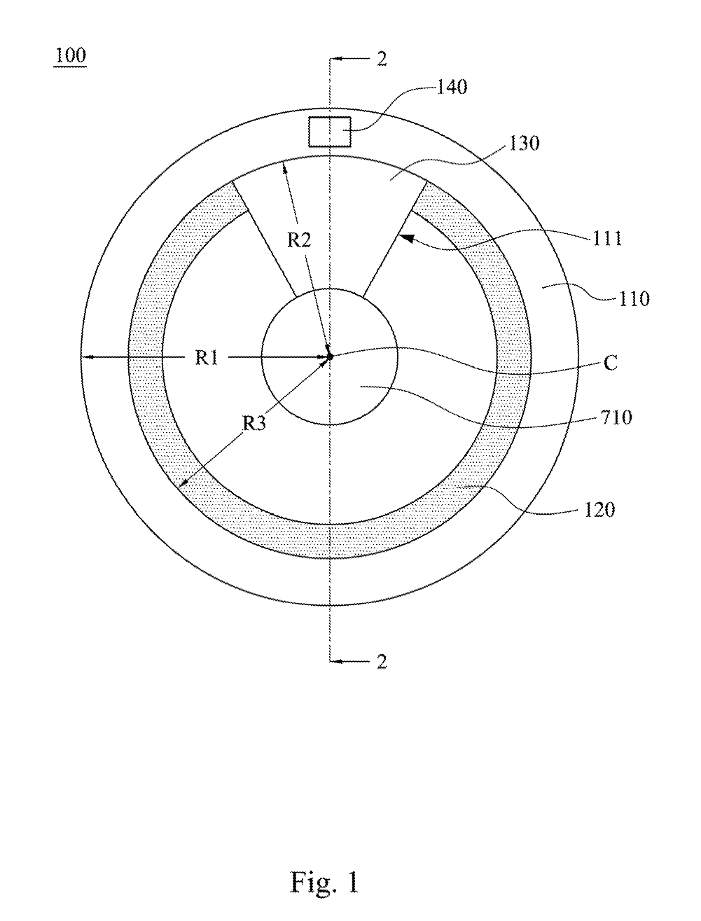

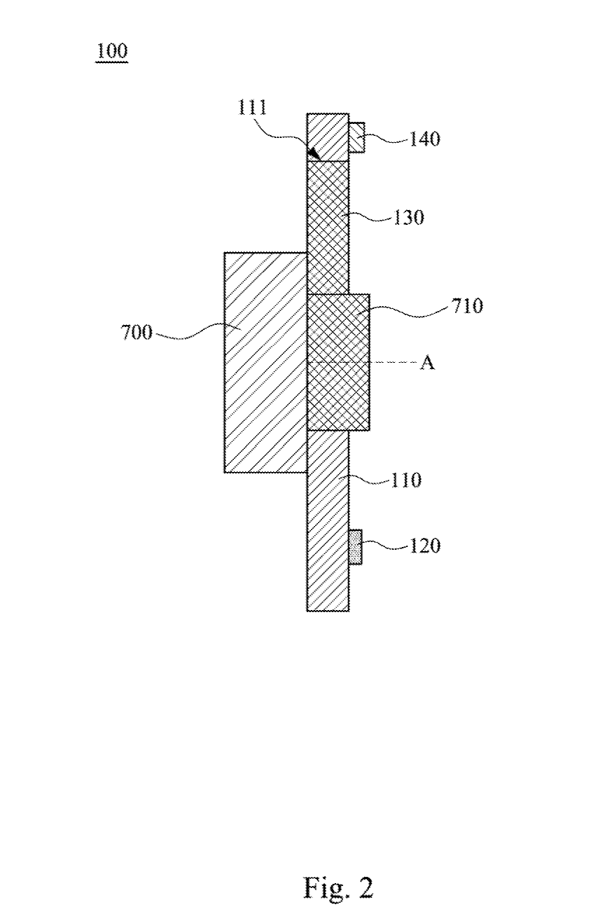

Reference is made to FIGS. 1 and 2. FIG. 1 is a front view of a wavelength converter 100 according to an embodiment of the disclosure. FIG. 2 is across-sectional view of the wavelength converter 100 in FIG. 1 taken along line 2-2. As shown in FIGS. 1 and 2, in the embodiment, the wavelength converter 100 includes a substrate 110, a phosphor layer 120, and a light transmission member 130. The substrate 110 is sleeved onto a drive shaft 710 of a motor 700 and has a hollow hole 111 The hollow hole 111 is located within an outer edge of the substrate 110. The phosphor layer 120 is disposed on the substrate 110 and adjoins the hollow hole 111. The light transmission member 130 is embedded in the hollow hole 111.

Because the light transmission member 130 is embedded in the hollow hole 111, a portion of the substrate 110 must serve as a retaining wall structure to fix the light transmission member 130 in a mechanical interlocking manner and resist the centrifugal force during rotation, so as to prevent the light transmission member 130 from being separated from the substrate 110. Specifically, the outer edge of the substrate 110 has a first outer diameter RI relative to an axis A of the drive shaft 710 (in FIG. 1, the axis A of the drive shaft 710 is not shown owing to coinciding with an equivalent centroid C but can be referred to FIG. 2). An outer edge of the hollow hole 111 has a second outer diameter R2 relative to the axis A of the drive shaft 710. An outer edge of the phosphor layer 120 has a third outer diameter R3 relative to the axis A of the drive shaft 710. The first outer diameter R1 is greater than the second outer diameter R2. The second outer diameter R2 is equal to or greater than the third outer diameter R3.

With the foregoing structural configuration, it can be seen that the hollow hole 111 of the substrate 110 is not communicated with the outer edge of the substrate 110 and the light transmission member 130 fills the space of the hollow hole 111, so the wavelength converter 100 of the present embodiment can maintain the shape of a circular symmetrical structure and can avoid the wind noise caused by the conventional substrate with the through hole design. Moreover, compare with a conventional wavelength converter adopting the conventional substrate with the through hole design, the light transmission member 130 embedded in the hollow hole 111 can move the equivalent centroid C of the wavelength converter 100 (i.e., the equivalent center of mass of the wavelength converter 100) toward the axis A of the drive shaft 710 (see FIG. 2), so the wavelength converter 100 of the present embodiment has a better dynamic balance,

Furthermore, because the density of the substrate 110 is generally different from that of the light transmission member 130, the rotating balance of the wavelength converter 100 must be considered after the light transmission member 130 is embedded in the hollow hole 111. In view of this, the wavelength converter 100 of the embodiment further includes a centroid adjustment member 140. The centroid adjustment member 140 is disposed on the substrate 110 and located outside the outer edge of the phosphor layer 120 and an outer edge of the light transmission member 130. By disposing the centroid adjustment member 140 on the substrate 110, the equivalent centroid C of a combination of the substrate 110, the phosphor layer 120, the light transmission member 130, and the centroid adjustment member 140 is substantially located on the axis A of the drive shaft 710. In other words, by disposing the centroid adjustment member 140 on the substrate 110, the wavelength converter 100 can have a better rotating balance. In practical applications, the equivalent centroid C can be measured by special detection equipment which is not described in detail here.

In some embodiments, the substrate 110 is made of a high thermal conductivity material, but the disclosure is not limited in this regard. In some embodiments, a portion of the substrate 110 located outside the outer edge of the phosphor layer 120 and the outer edge of the light transmission member 130 is substantially ring-shaped. Therefore the ring-shaped portion (a part of which forms the retaining wall structure located at the outer side of the light transmission member 130) of the substrate 110 can effectively increase the heat dissipating area and the heat capacity of the substrate 110 so as to improve the cooling efficiency.

In some embodiments, the light transmission member 130 is made of a transparent material, such as SiO2, CaF2, sapphire, and etc., but the disclosure is not limited in this regard. In some other embodiments, an antireflective coating film and/or an antistatic coating film can be disposed on a surface of the light transmission member 130.

In the embodiment, the centroid adjustment member 140 disposed on the substrate 110 is a weight-loading member. In some embodiments, the density of the substrate 110 is greater than that of the light transmission member 130. Under the circumstances, as shown in FIGS. 1 and 2, to achieve the purpose of adjusting the equivalent centroid C of the wavelength converter 100 to the axis A of the drive shaft 710, the centroid adjustment member 140 and the light transmission member 130 are located at the same side of the axis A of the drive shaft 710.

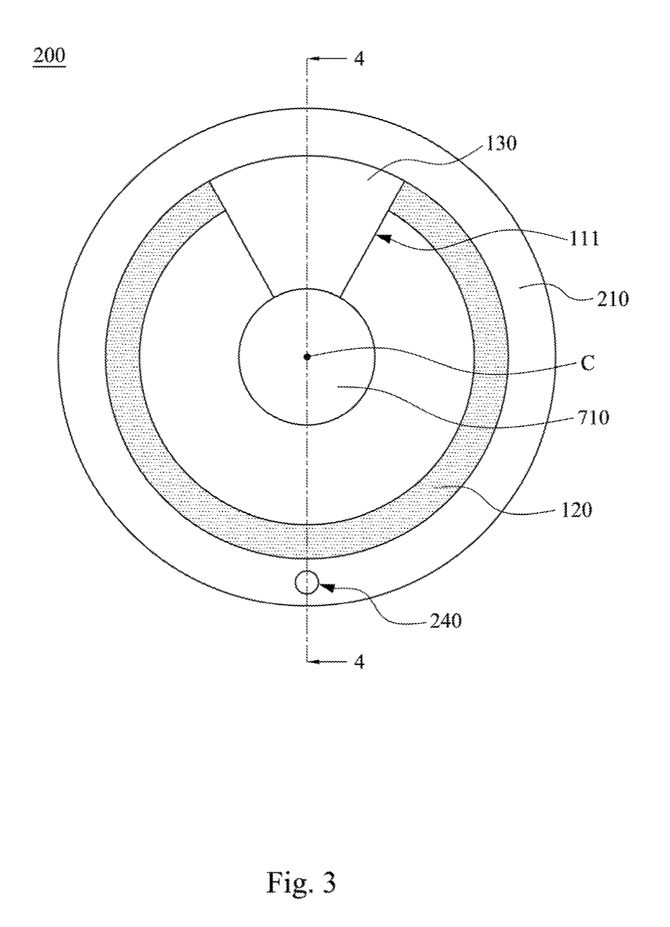

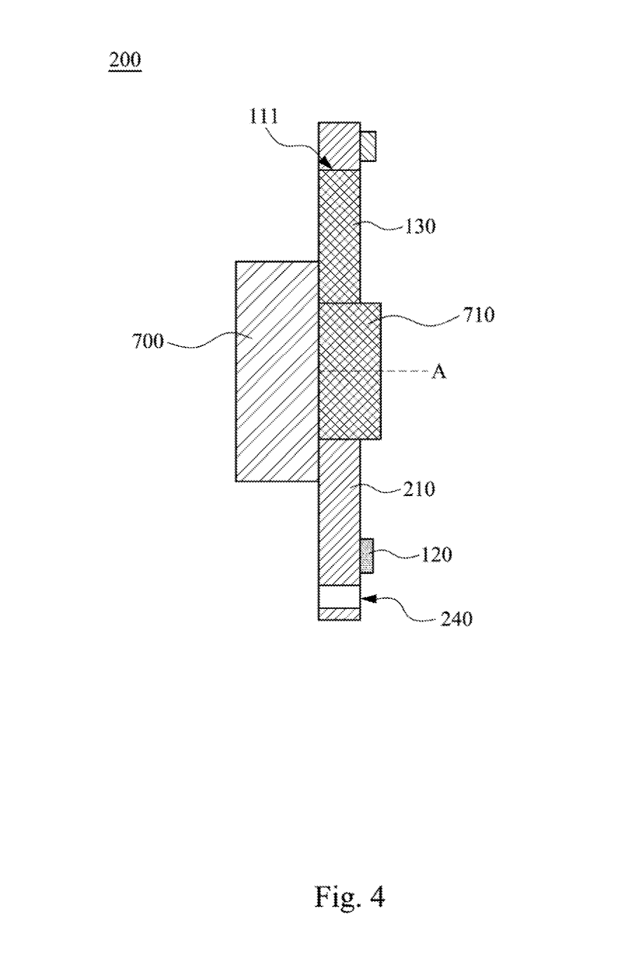

However, the disclosure is not limited in this regard. Reference is made to FIGS. 3 and 4. FIG. 3 is a front view of a wavelength converter 200 according to another embodiment of the disclosure. FIG. 4 is a cross-sectional view of the wavelength converter 200 in FIG. 3 taken along line 4-4. As shown in FIGS. 3 and 4, in the embodiment, the wavelength converter 200 includes a substrate 210, a phosphor layer 120, a light transmission member 130, and a centroid adjustment member 240, in which the structures and functions of the phosphor layer 120 and the light transmission member 130 and the connection relationships between each of the phosphor layer 120 and the light transmission member 130 and the substrate 210 are substantially similar to the embodiment of FIG. 1 and therefore are not repeated here to avoid duplicity. It should be pointed out that the difference between the wavelength converter 200 of the present embodiment and the wavelength converter 100 of FIG. 1 is that the centroid adjustment member 240 of the wavelength converter 200 of the present embodiment is a through hole formed on the substrate 210.

In some embodiments, the density of the substrate 210 is greater than that of the light transmission member 130. Under the circumstances, as shown in FIGS. 3 and 4, to achieve the purpose of adjusting the equivalent centroid C of the wavelength converter 200 to the axis A of the drive shaft 710, the centroid adjustment member 240 and the light transmission member 130 are located at the opposite sides of the axis A of the drive shaft 710.

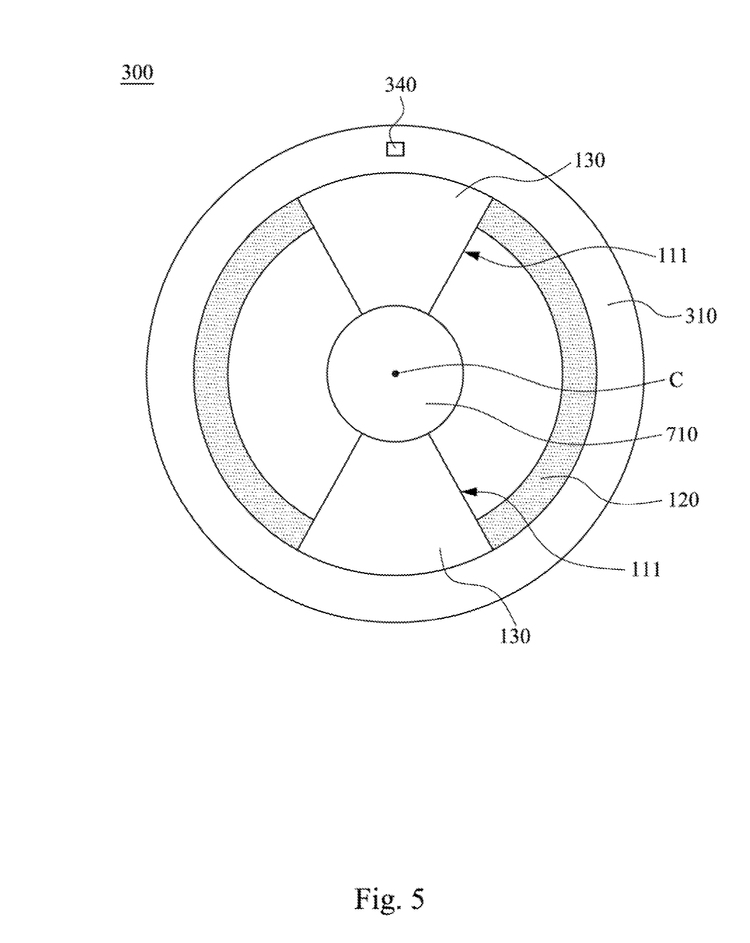

Reference is made to FIG. 5. FIG. 5 is a front view of a wavelength converter 300 according to another embodiment of the disclosure. As shown in FIG. 5. In the embodiment, the wavelength converter 300 includes a substrate 310, a phosphor layer 120, a light transmission member 130 and a centroid adjustment member 340, in which the structures and functions of the phosphor layer 120 and the light transmission member 130 and the connection relationships between each of the phosphor layer 120 and the light transmission member 130 and the substrate 310 are substantially similar to the embodiment of FIG. 1 and therefore are not repeated here to avoid duplicity. It should be pointed out that the difference between the wavelength converter 300 of the present embodiment and the wavelength converter 100 of FIG. 1 is that the wavelength converter 300 of the present embodiment has two hollow holes 1 11 and two tight transmission members 130. The light transmission members 30 are respectively embedded in the hollow, holes 111.

In some embodiments, as shown in FIG. 5, to achieve the purpose of adjusting the equivalent centroid C of the wavelength converter 300 to the axis A of the drive shaft 710, the axis A of the drive shaft 710 can be arranged to be substantially located between the hollow holes 111. Furthermore, because the light transmission members 130 symmetrically disposed relative to the axis A of the drive shaft 710 have effectively improved the dynamic balance of the wavelength converter 300, the equivalent centroid C of the wavelength converter 300 can be adjusted to the axis A of the drive shaft 710 by disposing the centroid adjustment member 340 having a smaller mass on the substrate 310.

In practical applications, the number of the light transmission members 130 included in the wavelength converter 300 is not limited by the embodiment of FIG. 5 and can be flexibly modified as needed.

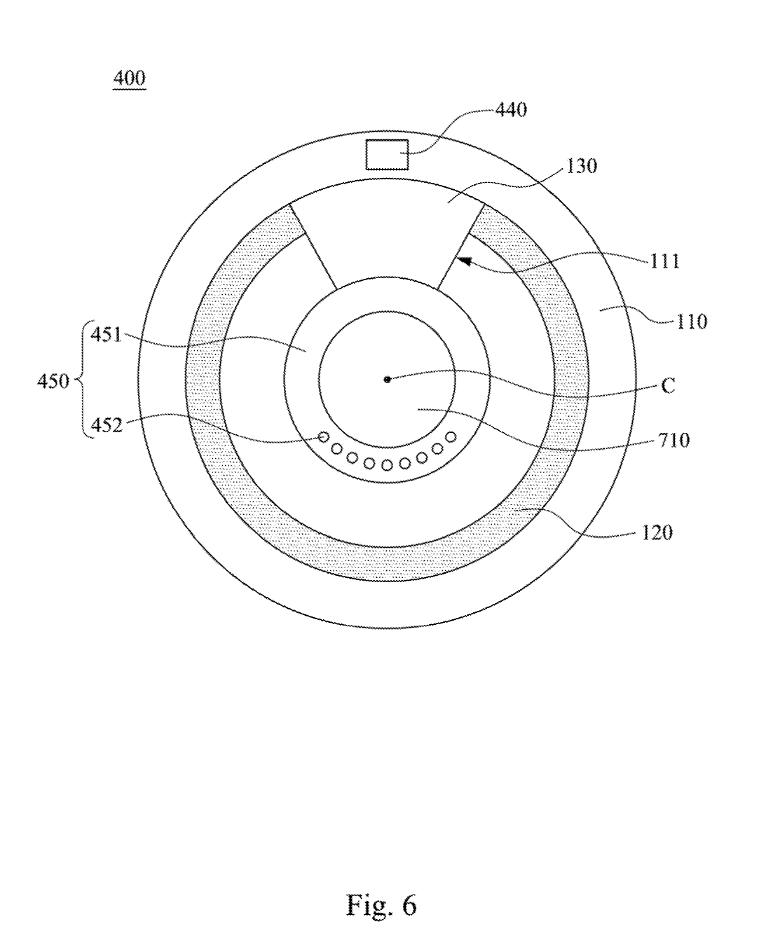

Reference is made to FIG. 6. FIG. 6 is a front view of a wavelength converter 400 according to another embodiment of the disclosure. As shown in FIG. 6, in the embodiment, the wavelength converter 400 includes a substrate 110, a phosphor layer 120, a light transmission member 130, a first centroid adjustment member 440, and a second centroid adjustment member 450, in which the structures and functions of the substrate 110, the phosphor layer 120 and the light transmission member 130 and the connection relationships therebetween are substantially similar tis the embodiment of FIG. 1 and the first centroid adjustment member 440 is similar to, the centroid adjustment member 140 of FIG. 1, so the components are not repeated here to avoid duplicity. It should be pointed out that the difference between the wavelength converter 400 of the present embodiment and the wavelength converter 100 of FIG. 1 is that the wavelength converter 400 of the present embodiment is additionally equipped with the second centroid adjustment member 450. The second centroid adjustment member 450 is disposed on the substrate 110 and located inside the inner edge of the phosphor layer 120. In particular, the equivalent centroid C (i.e., the equivalent center of mass of the wavelength converter 400) of a combination of the substrate 110, the phosphor ayes 120, the light transmission member 130, the first centroid adjustment member 440, and the second centroid adjustment member 450 is substantially located on the axis A of the drive shaft 710.

Specifically, the second centroid adjustment member 450 includes a collar 451 and a plurality of weight-loading members 452. The collar 451 is fixed to the substrate 110 and sleeved onto the drive shaft 710. The weight-loading members 452 are disposed on the collar 451. It should be pointed out that the distance between the first centroid adjustment member 440 and the axis A of the drive shaft 710 is greater than that between each of the weight-loading members 452 and the axis A of the drive shaft 710, so the influence of the adjustment of the mass of the first centroid adjustment member 440 causes to the equivalent centroid C of the wavelength converter 400 is greater than that of the adjustment of the mass of the weight-loading members 452 causes to the equivalent centroid C of the wavelength converter 400. Under the structural configuration, the wavelength converter 400 of the embodiment can roughly adjust the equivalent centroid C of the wavelength converter 400 to be close to the axis A of the drive shaft 710 by using the first centroid adjustment member 440, and then precisely adjust the equivalent centroid C of the wavelength converter 400 to the axis A of the drive shaft 710 by using the weight-loading members 452.

In some embodiments, the weight-loading members 452 of the second centroid adjustment member 450 can be balls but the disclosure is not limited in this regard.

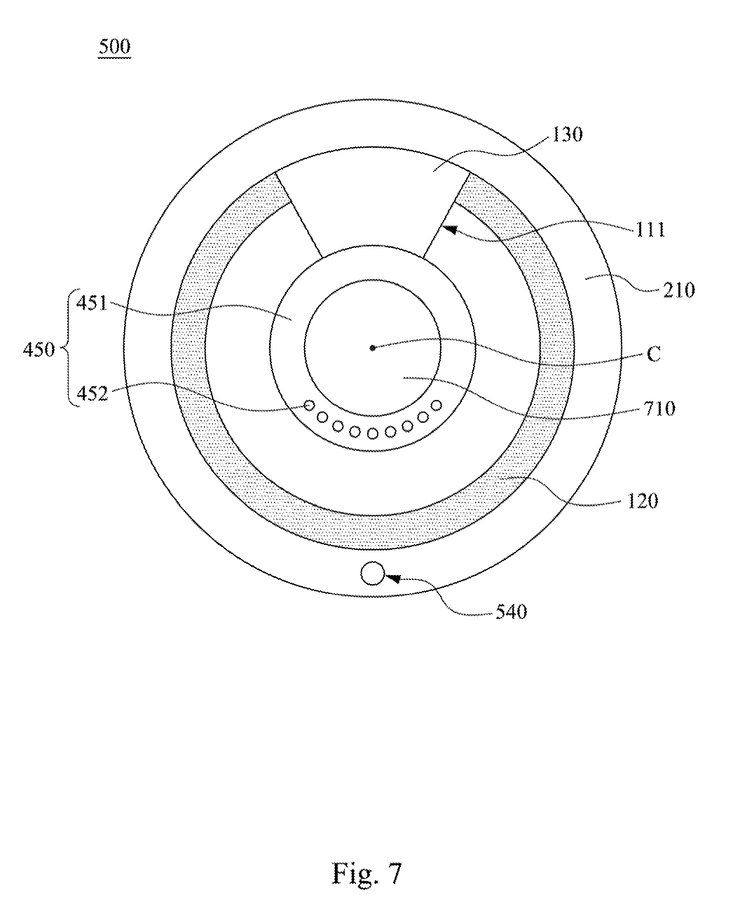

Reference is made to FIG. 7. FIG. 7 is a front view a wavelength converter 500 according to another embodiment of the disclosure. As shown in FIG. 7, in the embodiment, the wavelength converter 500 includes a substrate 210, a phosphor layer 120, a light transmission member 130, a first centroid adjustment member 540, and a second centroid adjustment member 450, in which the structures and functions of the phosphor layer 120 and the light transmission member 130 and the connection relationships between each of the phosphor layer 120 and the light transmission member 130 and the substrate 210 are substantially similar to the embodiment of FIG. 6 and therefore are not repeated here to avoid duplicity. It should be pointed out that the difference between the wavelength converter 500 of the present embodiment and the wavelength converter 400 of FIG. 6 is that the centroid adjustment member 540 of the wavelength converter 500 of the present embodiment is a through hole formed on the substrate 210.

In some embodiments, the density of the substrate 210 is greater than that of the light transmission member 130. Under the circumstances, as shown in FIG. 7, to achieve the purpose of adjusting the equivalent centroid C of the wavelength converter 500 to the axis A of the drive shaft 710, the first centroid adjustment member 540 and the light transmission member 130 are located at opposite sides of the axis A of the drive shaft 710.

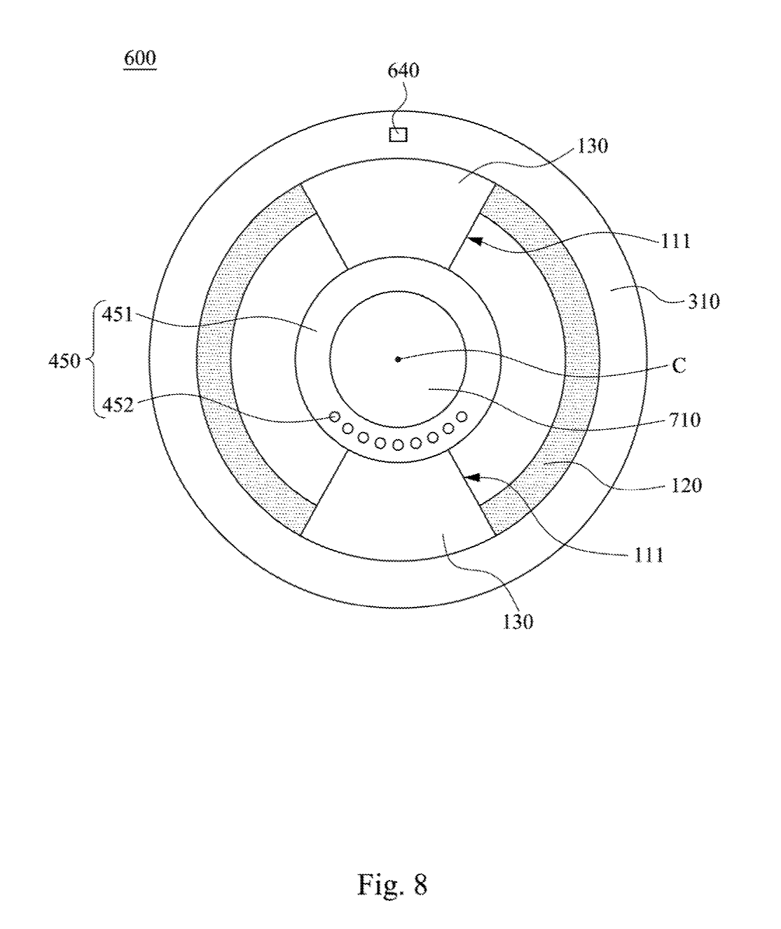

Reference is made to FIG. 8. FIG. 8 is a front view of a wavelength converter 600 according to another embodiment of the disclosure. As shown in FIG. 8, in the embodiment, the wavelength converter 600 includes a substrate 310, a phosphor layer 120, a light transmission member 130, a first, centroid adjustment member 640, and a second centroid adjustment member 450, in which the structures and functions of the phosphor layer 120 and the light transmission member 130 and the connection relationships between each of the phosphor layer 120 and the light transmission member 130 and the substrate 310 are substantially similar to the embodiment of FIG. 6 and therefore are not repeated here to avoid duplicity. It should be pointed out that the difference between the wavelength converter 600 of the present embodiment and the wavelength converter 400 of FIG. 6 is that the wavelength converter 600 of the members 130. The light transmission members 130 are respectively embedded in the hollow holes 111.

In some embodiments, as shown in FIG. 8, to achieve the purpose of adjusting the equivalent centroid C of the wavelength converter 600 to the axis A of the drive shaft 710, the axis A of the drive shaft 710 can be arranged to be substantially located between the hollow holes 111 Furthermore, because the light transmission members 130 symmetrically disposed relative to the axis A of the drive shaft 710 have effectively improved the dynamic balance of the wavelength converter 600, the equivalent centroid C of the wavelength converter 600 can be roughly adjusted to the axis A of the drive shaft 710 by disposing the first centroid adjustment member 640 having a smaller mass on the substrate 310. Furthermore, the equivalent centroid C of the wavelength converter 600 can be further precisely adjusted to the axis A of the drive shaft 710 by using the weight-loading members 452 of the second centroid adjustment member 450.

According to the foregoing recitations of the embodiments of the disclosure, it can be seen that the wavelength converter of the present disclosure can be applied in a 1-chip projector and has a design that the light transmission member is embedded in the hollow hole located within the outer edge of the substrate (i.e., the light transmission member is wrapped in the substrate). Hence, the wavelength converter of the present disclosure can maintain the shape of a circular symmetrical structure and can avoid the wind noise caused by the conventional substrate with the through hole design. The light transmission member embedded in the hollow hole and the centroid adjustment member disposed on the substrate can move the equivalent centroid of the wavelength converter to the axis of the drive shaft, so the wavelength converter of the present disclosure has a good dynamic balance. Furthermore, because the light transmission member is embedded in the hollow hole, a portion of the substrate must serve as a retaining wall structure to fix the light transmission member in a mechanical interlocking manner and resist the centrifugal force during rotation, so as to prevent the light transmission member from being separated from the substrate. In addition, the substrate can be made of metal, so the retaining wall structure can increase the heat dissipating area and the heat capacity of the substrate, and the cooling efficiency can be improved.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A wavelength converter, comprising;
a substrate configured to be sleeved onto a drive shaft of a motor, the substrate having a hollow hole located within an outer edge of the substrate;
a phosphor layer disposed on the substrate and adjoining the hollow hole;
a light transmission member embedded in the hollow hole; and
a centroid adjustment member disposed on the substrate and located outside an outer edge of the phosphor layer and an outer edge of the light transmission member,
wherein an equivalent centroid of a combination of the substrate, the phosphor layer, the light transmission member, and the centroid adjustment member is substantially located on an axis of the drive shaft.

2. The wavelength converter of claim 1 wherein the centroid adjustment member is a weight-loading member.

3. The wavelength converter of claim wherein the centroid adjustment member is a through hole.

4. The wavelength converter of claim 1, wherein the outer edge of the substrate has a first outer diameter relative to the axis of the drive shaft, an outer edge of the hollow hole has a second outer diameter relative to the axis of the drive shaft, the outer edge of the phosphor layer has a third outer diameter relative to the axis of the drive shaft, the first outer diameter is greater than the second outer diameter, and the second outer diameter is equal to or greater than the third outer diameter.

5. The wavelength converter of claim 1, wherein the substrate further has two of the hollow holes, the axis of the drive shaft is substantially located between the hollow holes, the wavelength converter further comprises two of the light transmission members, and the light transmission members are respectively embedded in the hollow holes.

6. The wavelength converter of claim 1, wherein a portion of the substrate located outside the outer edge of the phosphor layer and the outer edge of the light transmission member is substantially ring-shaped.

7. The wavelength converter of claim 1, wherein the substrate is made of

8. A wavelength converter, comprising:
a substrate configured to be sleeved onto a drive shaft of a motor, the substrate having a hollow hole located within an outer edge of the substrate;
a phosphor layer disposed on the substrate and adjoining the hollow hole;
a light transmission member embedded in the hollow hole;
a first centroid adjustment member disposed on the substrate and located outside an outer edge of the phosphor layer and an outer edge of the light transmission member; and
a second centroid adjustment member disposed on the substrate and located inside an inner edge of the phosphor layer,
wherein an equivalent centroid of a combination of the substrate, the phosphor layer, the light transmission member, the first centroid adjustment member, and the second centroid adjustment member is substantially located on an axis of the drive shaft.

9. The wavelength converter of claim 8, wherein the first centroid adjustment member is a weight-loading member.

10. The wavelength converter of claim 8, wherein the first centroid adjustment member is a through hole.

11. The wavelength converter of claim 8, wherein the second centroid adjustment member comprises:
a collar fixed to the substrate and configured to be sleeved onto the drive shaft; and
a plurality of weight-loading members disposed on the collar.

12. The wavelength converter of claim 8, wherein the outer edge of the substrate has a first outer diameter relative to the axis of the drive shaft, an outer edge of the hollow hole has a second outer diameter relative to the axis of the drive shaft, the outer edge of the phosphor layer has a third outer diameter relative to the axis of the drive shaft, the first outer diameter is greater than the second outer diameter, and the second outer diameter is equal to or greater than the third outer diameter,

13. The wavelength converter of claim 8, wherein the substrate further has two of the hollow holes, the axis of the drive shaft is substantially located between the hollow holes, the wavelength converter further comprises two of the light transmission members, and the light transmission members are respectively embedded in the hollow holes.

14. The wavelength converter of claim 8, wherein a portion of the substrate located outside the outer edge of the phosphor layer and the outer edge of the light transmission member is substantially ring-shaped.

15. The wavelength converter of claim 8, wherein the substrate is made of metal.
